(19) United States
(12) Patent Application Publication
(10) Pub. No.: US 2005/0077879 A1
(43) Pub. Date: Apr. 14, 2005

(54) Energy transfer device for series connected energy source and storage devices

(76) Inventor: Timothy Paul Near, Alpharetta, GA (US)

Correspondence Address: TIMOTHY PAUL NEAR, 310 CREEKVIEW TERRACE, ALPHARETTA, GA, 30005-4697, US

(21) Appl. No.: 10/924,581

(22) Filed: Aug. 24, 2004

Related U.S. Application Data
(60) Provisional application No. 60/511,053, filed on Oct. 14, 2003.

(51) Int. Cl. H02J 7/00

(52) U.S. Cl. 320/166

(57) ABSTRACT

A low cost, efficient, and rapid means for transferring energy or balancing charge among multiple, series connected batteries, capacitors, photovoltaic cells, fuel cells, and other types of energy source or storage devices is provided. Modules that transfer energy by moving charge from one or more series connected energy devices directly to one or more other energy devices in the string are disclosed. The modules utilize steering circuits comprised of switches and rectifiers, and energy storage elements such as inductors and transformers, to transfer energy between multiple energy devices in the string. The modules may be used in combination with string charging devices and loads. The modules provide a means to balance charge or potential of the energy devices, which is known to provide benefits of increased life and capacity.

### CROSS-REFERENCE TO RELATED APPLICATIONS

This application is entitled to the benefit of Provisional Patent Application No. 60/511,053 filed Oct. 14, 2003.

### BACKGROUND

1. Field of the Invention

This invention pertains generally to the field of power sources containing a number of energy source or storage devices connected in series, and specifically to circuits and methods for transferring or balancing energy, charge, or potential among series connected energy source or storage devices.

2. Description of Prior Art

Many systems incorporate batteries, capacitors, photovoltaic cells, fuel cells and other energy devices connected in series. These systems include standby power supplies, electric motor drives, electric vehicles, uninterruptible power supplies, fuel cell systems, and photovoltaic systems. Balancing the charge, voltage potential, or energy of each series connected energy device is critical in many applications. The ability to transfer charge in a series connected string of energy devices improves life and capacity of the string, and in some situations, prevents damage to or destruction of the energy devices. It can also prevent damage to other devices attached to the string.

With batteries, balancing is important to increase lifetime by reducing over-charging and over-discharging of individual batteries in series. It is also important in achieving full charging of all the batteries in a string and in maximizing the capacity of the string. With capacitors, balancing is important to prevent an over voltage condition on one or more of the devices and to maximize the energy storage capacity of the string of capacitors.

With fuel cells, transferring charge between series connected cells is important to prevent the voltage across any individual cell from being low enough to cause damage to the cell. As the power capacity of a string of fuel cells is determined by the cell with the lowest current capacity, and as the voltage across the lowest capacity cell drops the most as power output is increased, transferring charge between series connected fuel cells increases the power output capacity of the string. Thus transferring charge between fuel cells connected in series can increase both the lifetime and the power output of the string.

Schemes have been developed to balance charge among batteries and capacitors. One simple scheme uses a resistive shunt across each device in the series string. Current drawn from each energy device by the shunts is proportional to the voltage of each device, with higher voltage devices having a greater rate of discharge. This tends to reduce voltage differences among the devices. A disadvantage of this approach is that capacity of the string is reduced as energy drawn by the shunts is converted to heat and is not available to supply loads attached to the string. As shunts convert energy to heat, this approach also requires a means to dissipate relatively large amounts of heat to the surrounding environment. This generally increases the size and cost of the balancing device. Another disadvantage is that a shunt can cause over-discharging and damage unless it is disconnected when the energy device it is attached to is in a discharged or under voltage state.

A second approach to balancing charge among batteries in a string uses a transformer with multiple secondary windings. A primary winding is connected across the entire string. There are as many secondary windings as there are devices in the string, and one secondary winding is connected to each of the energy devices. A switch is modulated to transfer energy from the string to the primary winding, from the primary winding to the secondary windings, and from each secondary winding to the energy device connected to that winding. The transformer has closely matched the secondary windings so that more energy is transferred to secondary windings connected to lower potential energy devices. In this manner, lower charged devices receive more energy than higher charged devices. While a simple control circuit may be used with this approach, it has significant drawbacks. One serious disadvantage is that any mismatch between the characteristics of the secondary windings results in unbalanced voltages being applied to the batteries in the string. It is difficult and relatively expensive to construct a transformer with multiple secondary windings matched closely enough to provide adequate charge balancing. It is also difficult to maintain a close match between secondary windings across a range of operating conditions and throughout the life of the device. Applying this type of charge balancing device to a string of batteries may not only provide inadequate balancing, it may actually cause a charge imbalance, thereby reducing battery life and runtime instead of improving it. Another disadvantage is that, due to leakage inductance in the secondary windings, the lowest voltage device generally does not receive much more charge than the highest charged device. This results in slow and inefficient balancing as there are losses in the balancing circuit and only a small portion of the charge circulated out of the string and back into each individual device contributes to the balancing of the string.

Other approaches use bidirectional or single directional circuits that transfer charge from one battery in a string to an adjacent battery in the string. A number of these devices may be cascaded on a string of batteries, balancing charge by shuffling charge among sets of adjacent battery pairs. A disadvantage of these approaches is that to move charge from one battery in the string to another requires that charge first be transferred into, and then transferred out of, each battery between them. This can result in slow and inefficient transfer of charge. Another disadvantage of these approaches is that multiple circuits are needed on strings of more than two batteries. This generally requires additional components and cost. In addition, as these approaches have often packaged each circuit separately, they have the additional disadvantage of requiring the connection of more wires to the string, increasing the cost of installation and the likelihood of errors in connecting the wires to the string. Separately packaged, multiple devices also increase size and cost as each circuit carries the full cost of a separate package and wiring harness.

### SUMMARY

The present invention provides a low cost, efficient, and rapid means for transferring charge among multiple, series connected batteries, capacitors, photovoltaic cells, fuel cells, or other energy source or storage devices by moving charge from one or more of the energy devices directly to one or more other devices in the string.

### OBJECTS AND ADVANTAGES

In accordance with the present invention, an energy transfer module is provided for series connected strings of energy source or storage devices. The energy transfer module is capable of transferring energy simultaneously from one or more energy source or storage devices to other energy devices in the string. By applying one or more modules to a string of energy devices and by modulating the various switches in the modules, energy is transferred among the energy devices. In this manner, the modules provide a means to adjust the charge or potential of each energy device in the series connected string. The modules may be used to balance charge in a string, which can provide benefits of increased lifetime, increased energy storage capacity, and increased power output.

The energy transfer module will generally include a controller that monitors the charge or potential of the series connected energy devices and provides control signals to the energy transfer circuit. A variety of algorithms may be used to accomplish charge transfer and achieve the specific type of balancing desired. Different systems and applications of these systems may result in a variety of energy transfer circuits, control circuits, and algorithms being employed.

A major improvement of the present invention as compared to previous devices is its ability to simultaneously transfer charge among multiple energy devices in a string. While much of the prior art is limited to the transfer of charge between two adjacent energy devices, the present invention discloses configurations that transfer energy between multiple devices, including nonadjacent groups of energy devices in the string. In a number of the configurations disclosed, energy is transferred among multiple devices with just a single switch. The means and methods disclosed allow the construction of energy transfer devices which provide faster, more efficient charge balancing at a lower cost than was previously available.

Another improvement is that the controller may include a temperature sensor that senses temperature in the module and reduces the rate of energy transfer at higher temperatures. This feature provides the benefit of limiting the maximum temperature of the module, thereby preventing damage or reduced module life caused by excessively high temperatures. It also allows a more compact and cost effective energy transfer device that provides high energy transfer rates and fast balancing at normal and reduced ambient temperatures, while allowing operation across a wider range of ambient temperatures.

The present invention provides an improvement in being able to configure compact, low cost, optimized energy transfer devices for a variety of applications, each of which may have quite different requirements. The invention has the advantage of providing application specific solutions optimized for a specific number of series connected energy devices, for a specific set of unique requirements, embodied in a single, cost effective, easy to use module. At the same time it also provides for general purpose, standardized, modular solutions that support a variety of applications and series string sizes by applying one or more modules to a string. As compared to modular approaches that transfer energy between two energy devices in a series string, the present invention provides solutions where modules transfer energy between more than two devices. This allows the support of larger string sizes with standardized, general purpose modules, while at the same time requiring fewer modules and providing faster, more efficient charge equalization at lower costs than previous solutions using two device modules. For example, while a string of seven batteries requires the cascading of six two-device modules, the same string only requires three three-device modules, two four-device modules, or one seven-device module.

Another advantage of the energy transfer system of the present invention is that it may be used in conjunction with one or more charger. Each charger may be connected across any number of adjacent energy devices. The energy transfer system may be used to compensate for differences in the amount of charge applied to each device in the string, to compensate for differences in the charge capacity of each device in the string, or to compensate for both charging rate and capacity differences.

The energy transfer system disclosed also has an additional advantage in that it may be used in conjunction with one or more load. Each load may be connected across any number of adjacent energy devices. The energy transfer system may be used to compensate for differences in the amount of load drawn from each device in the string, to compensate for differences in the charge capacity of each device in the string, or to compensate for both load and capacity differences.

Thus an improved method and means for transferring charge between series connected energy devices, including batteries, capacitors, photovoltaic cells, fuel cells, and other energy source and storage devices is disclosed. The invention provides means for a variety of improvements in cost, size, efficiency, speed of charge equalization, and ease of application to a wide range of application requirements.

### BRIEF DESCRIPTION OF THE DRAWINGS

FIG. 1 is a general illustration of an energy transfer system in accordance with the principles of the present invention.

FIG. 2 is a general illustration of an energy transfer element in accordance with the principles of the present invention.

FIG. 3 is an illustration of an energy transfer element with input terminals connected across one string device and output terminals connected across two adjacent string devices.

FIG. 4 is an illustration of an energy transfer element with input terminals connected across one string device and two pairs of output terminals connected across the string devices above and below the input terminals.

FIG. 5 is a specific illustration of an energy transfer element in accordance with the principles of the present invention.

FIG. 6 is a specific illustration of an energy transfer element in accordance with the principles of the present invention.

FIG. 7 is a specific illustration of an energy transfer circuit for four energy devices connected in series in accordance with the principles of the present invention.

FIG. 8 is a specific illustration of an energy transfer element in accordance with the principles of the present invention.

FIG. 9 is a specific illustration of an energy transfer element in accordance with the principles of the present invention.

FIG. 10 is a specific illustration of an energy transfer element in accordance with the principles of the present invention.

FIG. 11 is a specific illustration of an energy transfer element in accordance with the principles of the present invention.

FIG. 12 is a specific illustration of an energy transfer element in accordance with the principles of the present invention.

FIG. 13 is a specific illustration of an energy transfer element in accordance with the principles of the present invention.

FIG. 14 is a specific illustration of an energy transfer element in accordance with the principles of the present invention.

FIG. 15 is a specific illustration of an energy transfer element in accordance with the principles of the present invention.

FIG. 16 is a specific illustration of an energy transfer element in accordance with the principles of the present invention.

FIG. 17 is a specific illustration of an energy transfer element in accordance with the principles of the present invention.

FIG. 18 is a specific illustration of an energy transfer element in accordance with the principles of the present invention.

FIG. 19 is a specific illustration of an energy transfer element in accordance with the principles of the present invention.

FIG. 20 is a specific illustration of an energy transfer circuit for four energy devices connected in series in accordance with the principles of the present invention.

FIG. 21 is a specific illustration of an energy transfer circuit for four energy devices connected in series in accordance with the principles of the present invention.

FIG. 22 is a specific illustration of an energy transfer circuit for four energy devices connected in series in accordance with the principles of the present invention.

FIG. 23 is a specific illustration of an energy transfer circuit for four energy devices connected in series in accordance with the principles of the present invention.

FIG. 24 is a specific illustration of an energy transfer circuit for four energy devices connected in series in accordance with the principles of the present invention.

### REFERENCE NUMERALS IN DRAWINGS

50 Energy Source or Storage Device
52 Energy Transfer Circuit
54 Controller
56 Energy Transfer Element
58 Input Terminal
59 Controller Input Signals
60 Output Terminal
61 Controller Output Signals
62 Steering Circuit
66 Energy Storage Element
68 Input and Output Terminal
70 Switch
72 Rectifier
74 Transformer Primary Winding
76 Transformer Secondary Winding

In the drawings, where multiple items of the same type are represented and it is necessary to reference a particular item, all items of the same type have the same reference number but different alphabetic suffixes.

### DESCRIPTION—MAIN EMBODIMENT

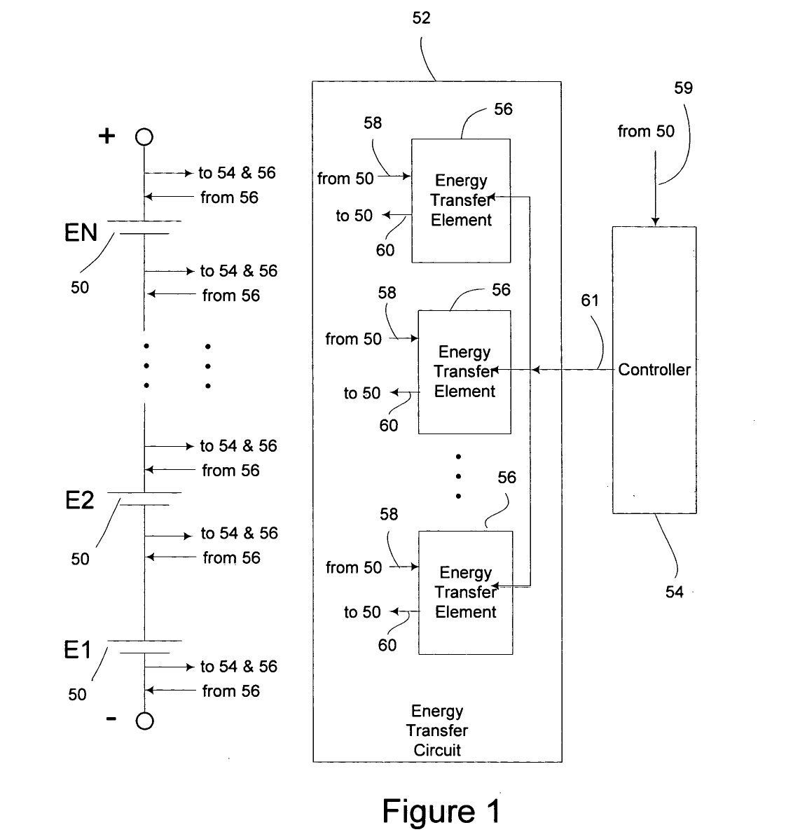

As illustrated in FIG. 1, the energy transfer system is comprised of a series string of two or more energy devices 50 connected to an energy transfer circuit 52 and a controller 54. Generally, the energy devices are batteries or capacitors, although they may be other types of energy source or storage devices such as photovoltaic cells and fuel cells. An energy device may also be comprised of a combination of multiple energy devices. For example, the energy device may be a paralleled capacitor and photovoltaic cell, or it may be comprised of a combination of a battery and filters containing capacitors and inductors to reduce high frequency current fluctuations in the battery.

The energy transfer circuit 52 consists of one or more energy transfer elements 56. The controller 54 provides control output signals 61 to the energy transfer circuit to transfer energy between the energy devices 50 in the string. In many applications, it is desired to maintain the same voltage across each of the energy devices in the string. In this case, the controller has input signals 59 to monitor the potential across each energy device and provides control signals 61 to the energy transfer elements to transfer energy from higher voltage energy devices 50 to lower voltage devices 50.

### OPERATION—MAIN EMBODIMENT

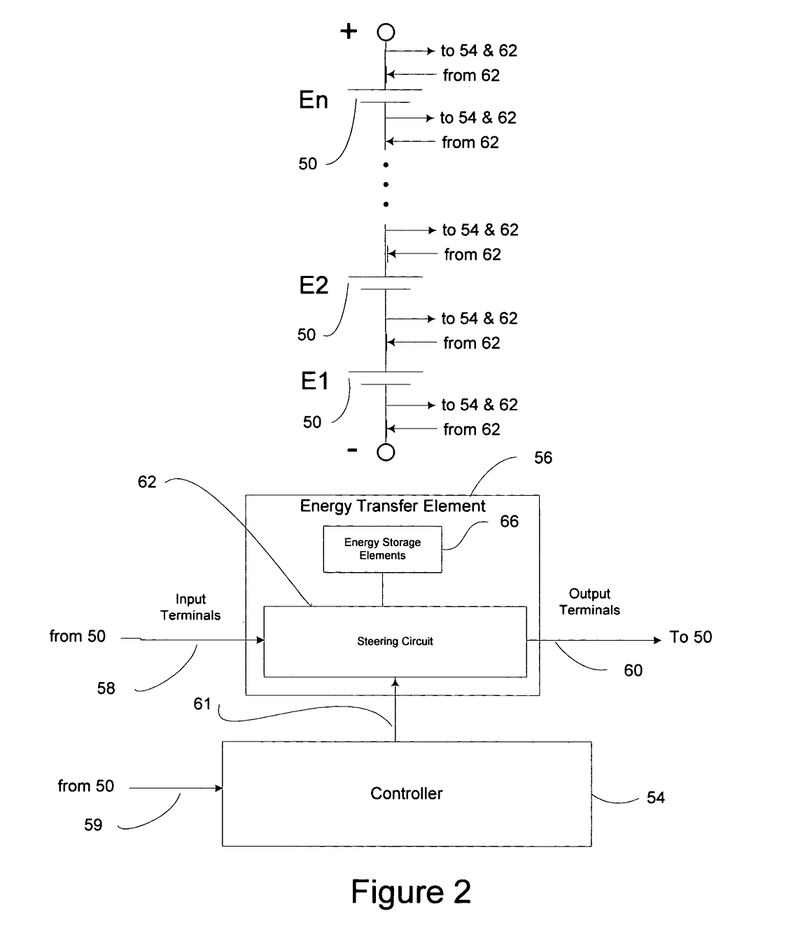

As illustrated in FIG. 2, each energy transfer element 56 consists of a steering circuit 62 and one or more energy storage elements 66. The steering circuit 62 is connected across the energy devices 50 from which energy is removed. The steering circuit 62 is also connected across the energy devices 50 to which energy is transferred. The controller 54 provides control signals 61 to the steering circuit 62 such that energy is transferred from the energy devices 50 connected across the input terminals 58 to the energy storage elements 66 and from the energy storage elements 66 to the energy devices 50 connected across the output terminals 60. The energy storage elements 66 are commonly inductors or transformers, although other types of energy storage elements or combinations of elements may also be utilized. The steering circuit 62 generally consists of one or more switch, and one or more rectifier, although addition circuit components may be used as well.

Many configurations are possible for the energy transfer elements and the energy transfer circuit may contain combinations of more than one type of element. One or more configurations of energy transfer elements may be employed to transfer energy from a variety of combinations of energy devices in the string to many other combinations of energy devices in the string. It is also possible to transfer energy from a variety of combinations of energy devices in the string to many other combinations of energy devices in the string with a single type of energy transfer element simply by changing where the input and output terminals are connected to the string. Thus by applying one or more energy transfer elements, with each element connected to appropriate junction points between energy devices in the string, a variety of energy transfer circuits may be constructed, and a construction best suited for a specific application may be construed.

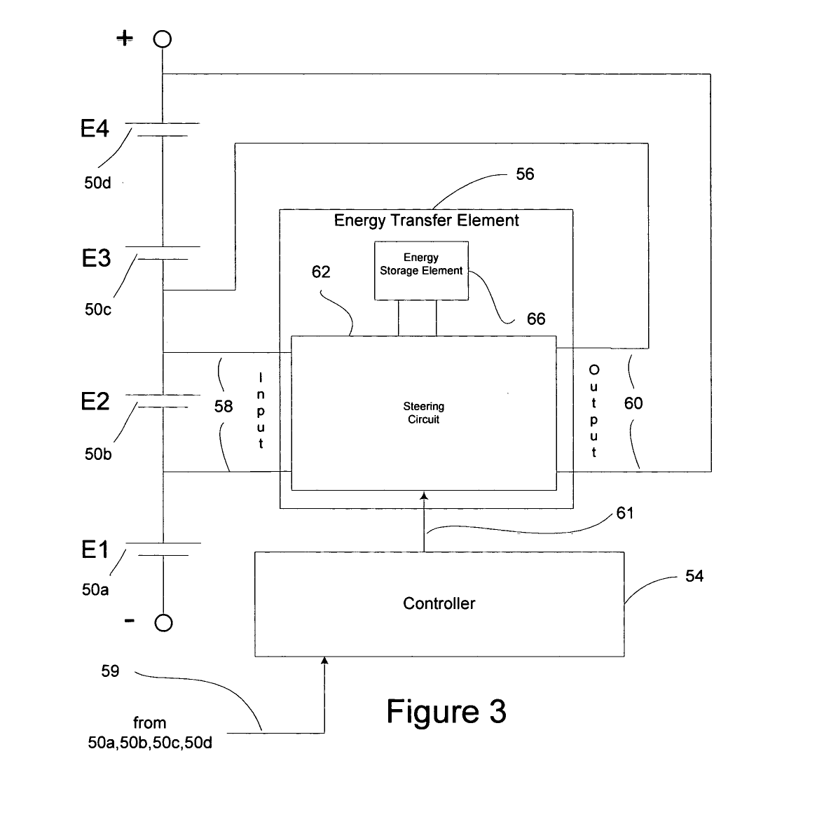

FIG. 3 shows one specific configuration of input and output terminal connections for an energy transfer element with two input terminals 58 and two output terminals 60. In this configuration, the energy transfer element removes energy from the energy device 50b connected across its two input terminals 58 and transfers energy to the upper two energy devices 50c and 50d connected across the two output terminals 60.

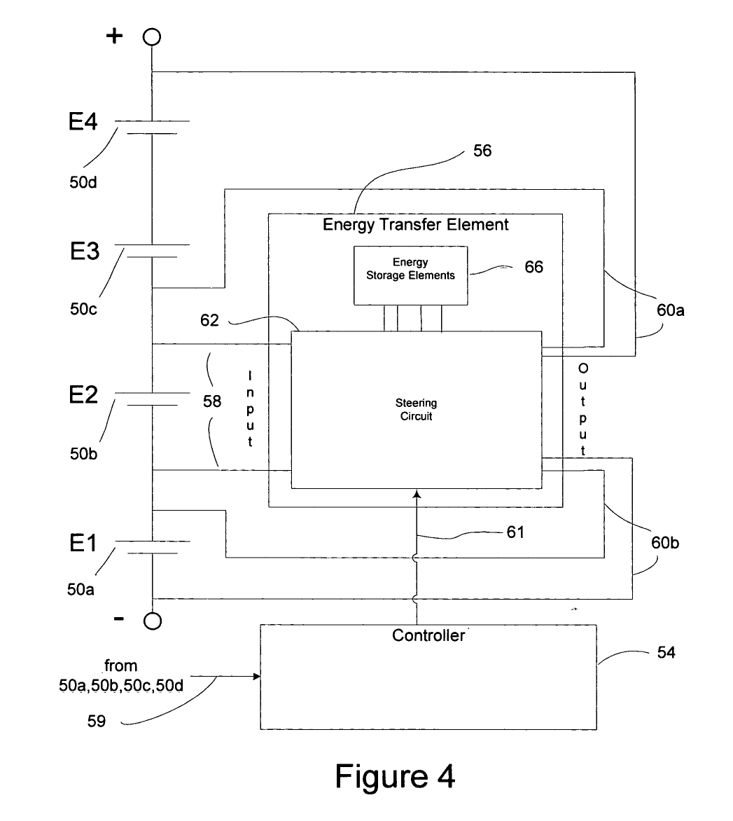

FIG. 4 shows another configuration of an energy transfer element with two input terminals 58 and four output terminals 60a and 60b. In this configuration, the circuit removes energy from the energy device 50b connected across its two input terminals 58 and transfers it to the upper two energy devices 50c and 50d connected across the first pair of output terminals 60a, and to the lowest energy device 50a connected across the second pair of output terminals 60b.

### DESCRIPTION AND OPERATION—ALTERNATIVE EMBODIMENTS

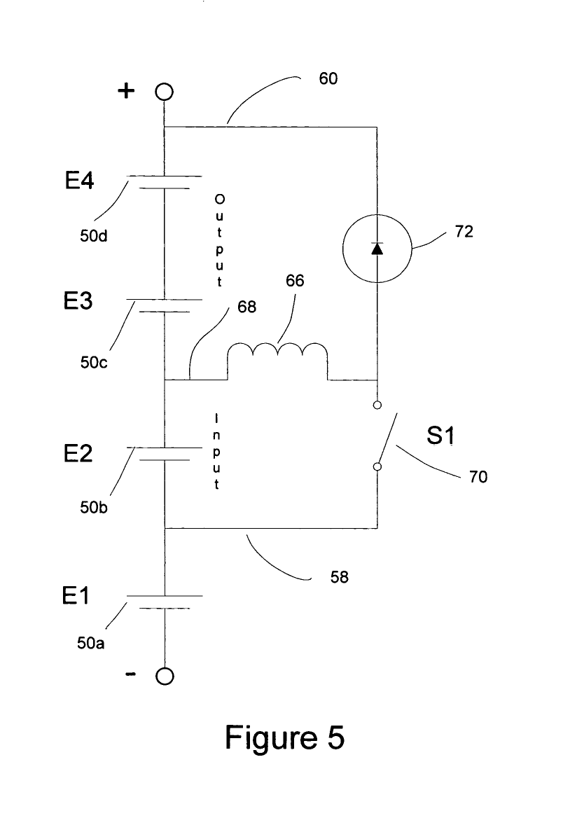

FIG. 5 illustrates one type of an energy transfer element 56 with one pair of input terminals and one pair of output terminals where one of the input terminals and one of the output terminals share a common terminal 68. The steering circuit consists of a single switch 70 and a single rectifier 72. The energy storage element 66 is an inductor. This energy transfer element transfers energy from one or more energy devices connected across input terminals 58 and 68 to one or more energy devices connected across output terminals 60 and 68. The energy devices to which charge is added are adjacent to and at a higher potential than the devices from which charge is removed. When connected to the string as shown in FIG. 5, this energy transfer element removes energy from the energy device 50b and transfers it to the energy devices 50c and 50d. When the switch 70 is closed, current ramps up in inductor 66, conducting through inductor 66, switch 70, and energy device 50b, thereby removing energy from energy device 50b. Opening switch 70 causes the current in inductor 66 to decrease, conducting through inductor 66, rectifier 72, energy device 50c and energy device 50d, thereby transferring energy to devices 50c and 50d.

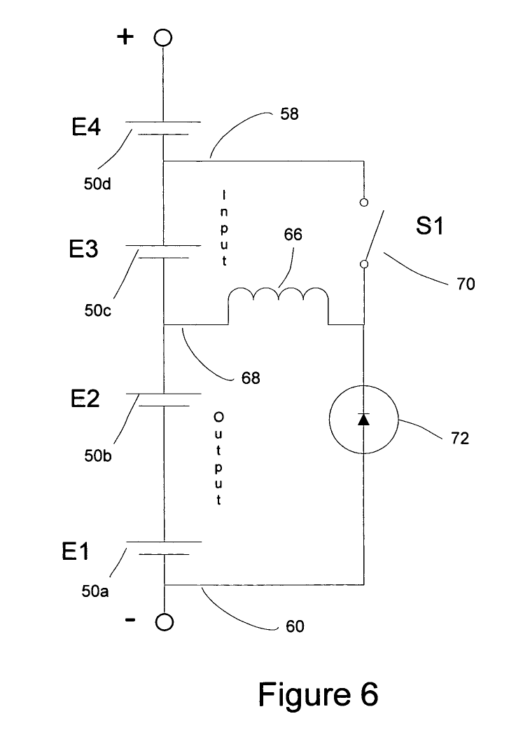

FIG. 6 illustrates another energy transfer element which is similar to that shown in FIG. 5 in all aspects except that the energy devices that charge is added to are at a lower potential than the energy devices that charge is taken from. When connected to the string as shown in FIG. 6, this energy transfer element removes energy from energy device 50c connected across input terminals 58 and 68 and transfers it to energy devices 50a and 50b connected across output terminals 60 and 68. When switch 70 is closed, current ramps up in inductor 66, conducting through inductor 66, switch 70, and energy device 50c, thereby removing energy from energy device 50c. Opening the switch 70 causes the current in inductor 66 to decrease, conducting through inductor 66, rectifier 72, energy device 50a and energy device 50b, thereby transferring energy to energy devices 50a and 50b.

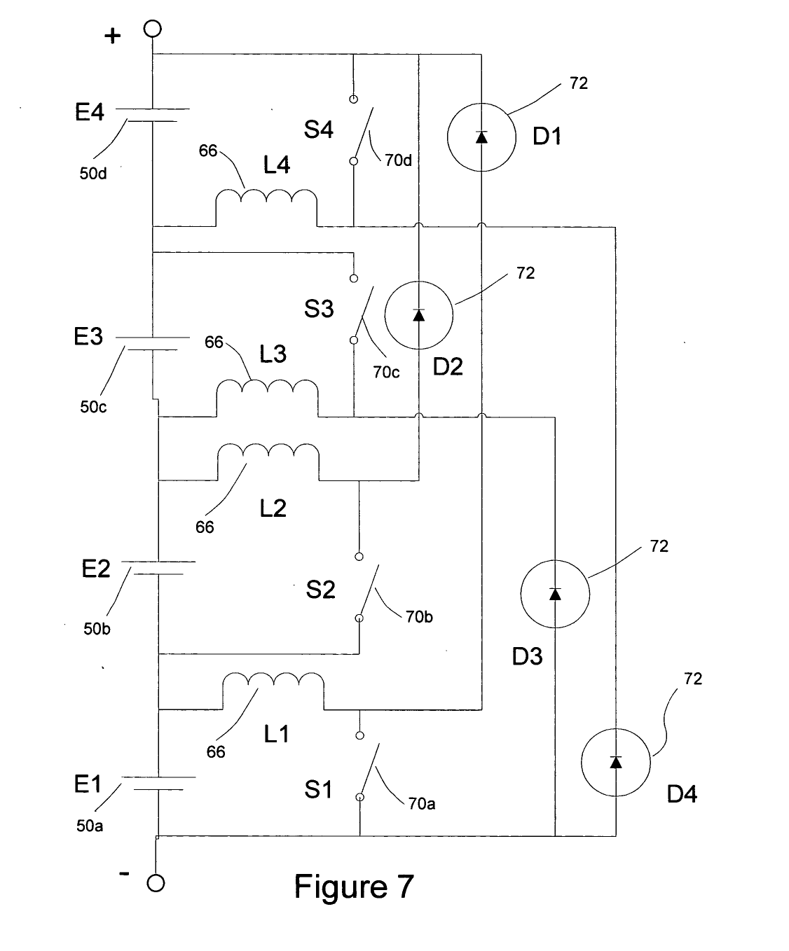

FIG. 7 illustrates one way the energy transfer elements illustrated in FIG. 5 and FIG. 6 may be applied to a series string of four energy devices. This energy transfer circuit allows energy to be transferred out of any of the four energy devices 50a, 50b, 50c, or 50d, and redistributed to the other energy devices, enabling the charge in the four energy devices 50a, 50b, 50c, and 50d to be balanced. Two energy transfer elements of the type illustrated in FIG. 5 are utilized. The first transfers energy from energy device 50a to energy devices 50b, 50c, and 50d when switch 70a is modulated. The second transfers energy from energy device 50b to energy devices 50c and 50d when switch 70b is modulated. Two energy transfer elements of the type illustrated in FIG. 6 are also utilized. The first transfers energy from energy device 50d to energy devices 50a, 50b, and 50c when switch 70d is modulated. The second transfers energy from energy device 50c to energy devices 50a and 50b when switch 70c is modulated.

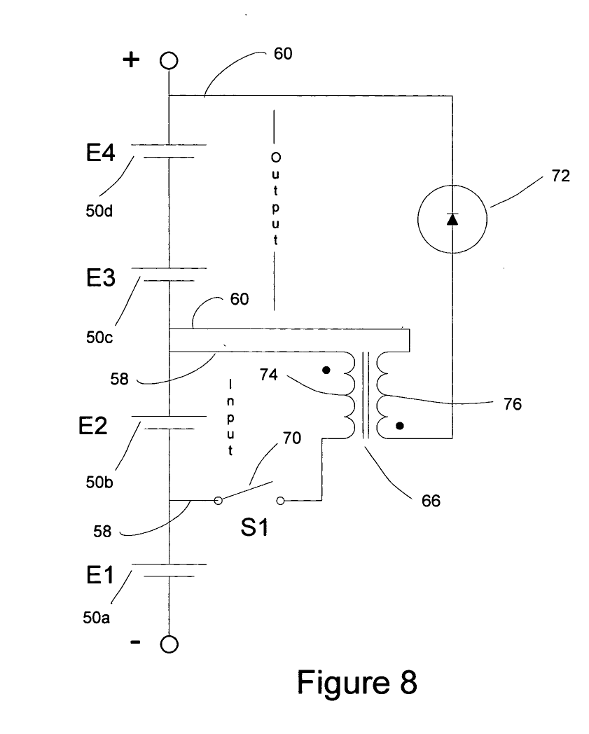

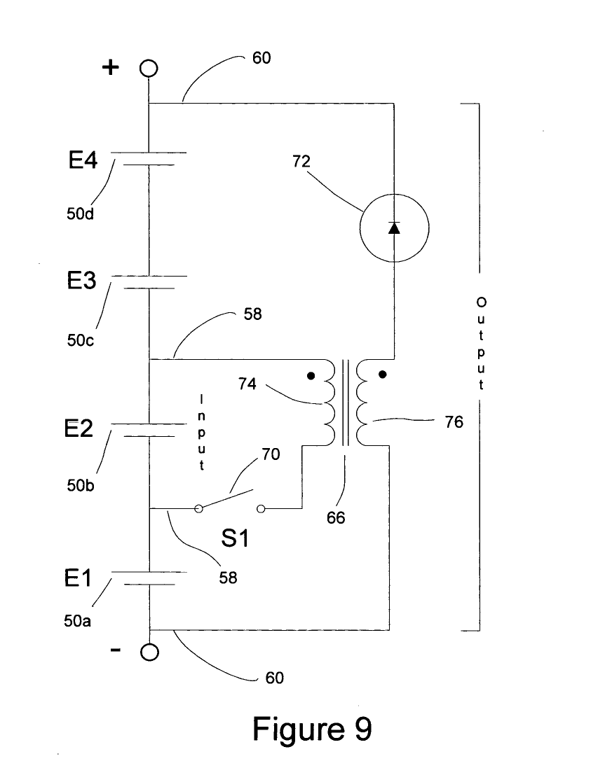

FIG. 8 shows an energy transfer element similar to the one illustrated in FIG. 5 and FIG. 6. It also has one pair of input terminals 58 and one pair of output terminals 60. A single switch 70 and a single diode 72 comprise the steering circuit. However, in this circuit, the energy storage element 66 is a transformer. When switch 70 is closed, current ramps up in the primary winding 74 of the transformer, conducting through the primary winding 74, the switch 70, and energy device 50b, thereby removing charge from energy device 50b. Opening the switch 70 causes the current to transfer to the transformer secondary winding 76. The current decreases, conducting through the secondary winding 76, the rectifier 72, energy device 50c, and energy device 50d, thereby transferring charge to energy devices 50c and 50d. An advantage of this energy transfer element is that the output terminals 60 may be connected across any energy device 50 in the string or across a plurality of adjacent energy devices 50. FIG. 9 illustrates this same energy transfer element where the output terminals 60 are connected across the entire string. In this configuration, modulating the switch 70 transfers charge out of the energy device 50b and redistributes this charge equally into all of the energy devices 50a, 50b, 50c, and 50d in the string.

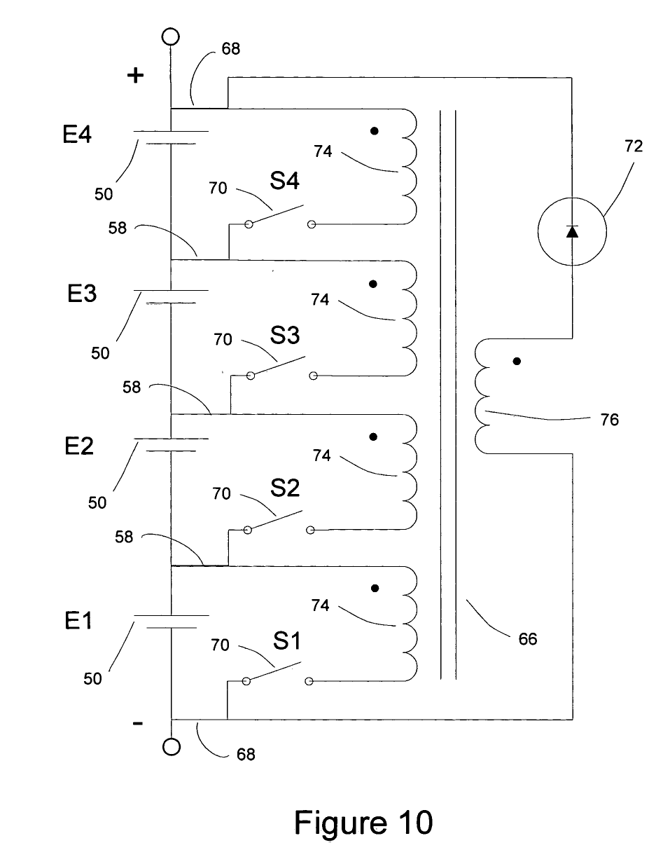

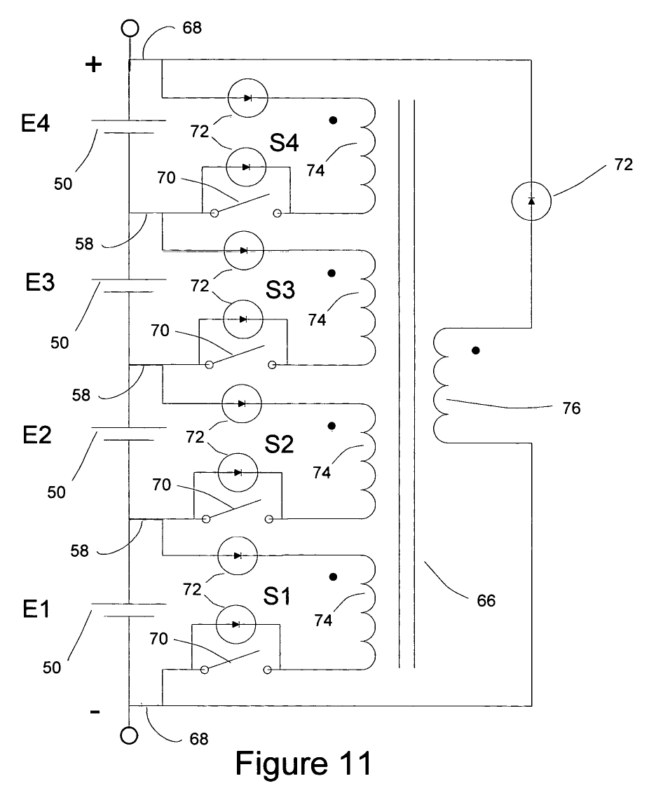

Applying one energy transfer element of the type shown in FIG. 9 across each energy device in a series connected string, with output terminals connected across the entire string, provides a quick and efficient energy transfer circuit for balancing charge. A further simplification to this type of energy transfer circuit may be obtained by replacing all of the individual transformers with a single transformer having as many primary windings 74 as there are energy devices in the string, and having a single secondary winding 76 and a single rectifier 72. Such an energy transfer circuit is illustrated in FIG. 10. It will be noted by those skilled in the art that additional steering circuit elements may be required for some applications of this energy transfer element. For example, FIG. 11 illustrates an application of the energy transfer element illustrated in FIG. 10 where the switching device 70 used is a MOSFET. A MOSFET may be modeled as a parallel combination of a simple switch 70 and a rectifier 72. To prevent coupling of current between primary windings 74 and to provide an additional benefit of reverse polarity protection, a rectifier 72 has been added to each primary winding circuit.

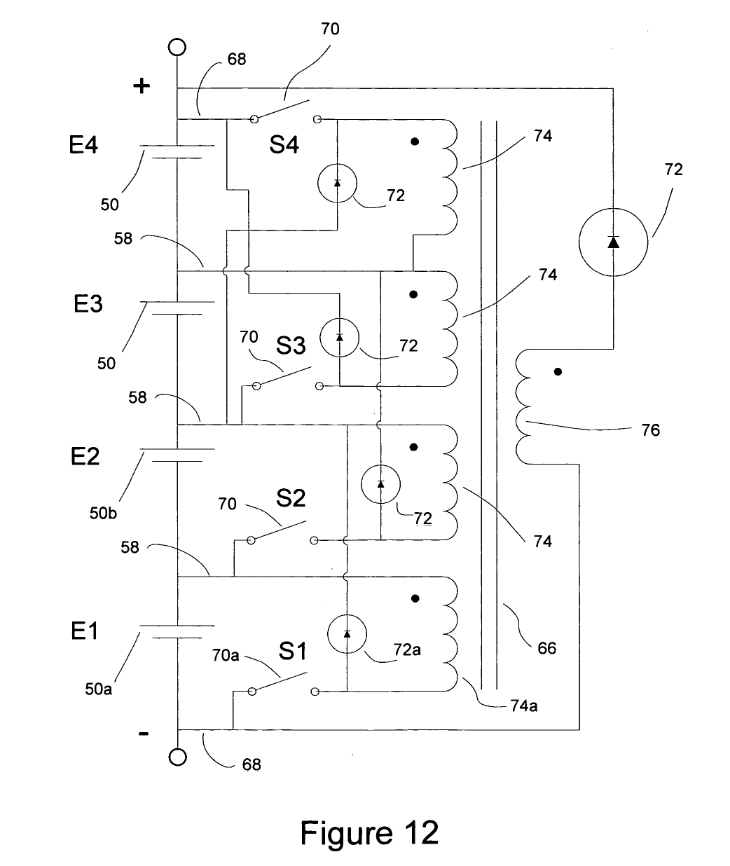

FIG. 12 illustrates a variation of the circuit in FIG. 10 where a rectifier 72 has been added to each primary circuit and provides an additional benefit of allowing stored energy in a primary circuit to be recovered and transferred to energy devices adjacent to the energy device from which charge is being removed. For example, when switch 70a is opened, the current flowing in the primary winding 74a is routed into the energy storage device 50b through the rectifier 72a, transferring magnetic and inductive current stored in the primary winding 74a to energy device 50b.

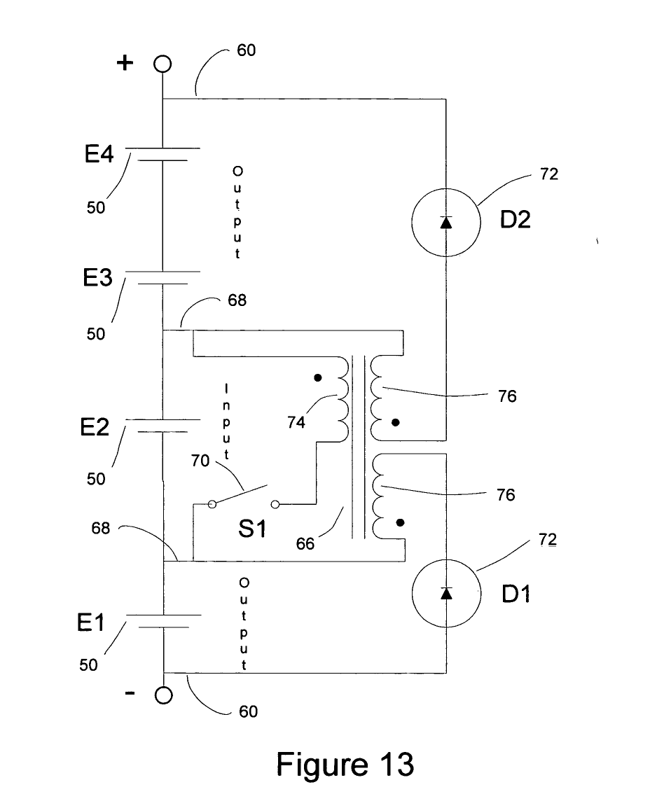

FIG. 13 illustrates an energy transfer element similar to the energy transfer element in FIG. 8 except that an additional secondary winding 76 has been added to the transformer along with a second pair of output terminals. As previously described, the energy transfer element in FIG. 8 transfers charge from the energy devices across the pair of input terminals 68 to all of the devices in the string. The energy transfer element of FIG. 13 redistributes the charge to the string devices above the input terminals and to the devices below the input terminals, without redistributing charge into the devices across the input terminals. This can result in even faster and more efficient energy transfer among string devices. The steering circuit consists of a single switch 70 and two rectifiers 72. The energy storage element 66 is a transformer with one primary winding 74 and two secondary windings 76. Connected to the string as shown in FIG. 13, the energy transfer element transfers energy from the energy device 50b connected across the input terminals 68 to all of the other energy devices 50a, 50c, and 50d in the string.

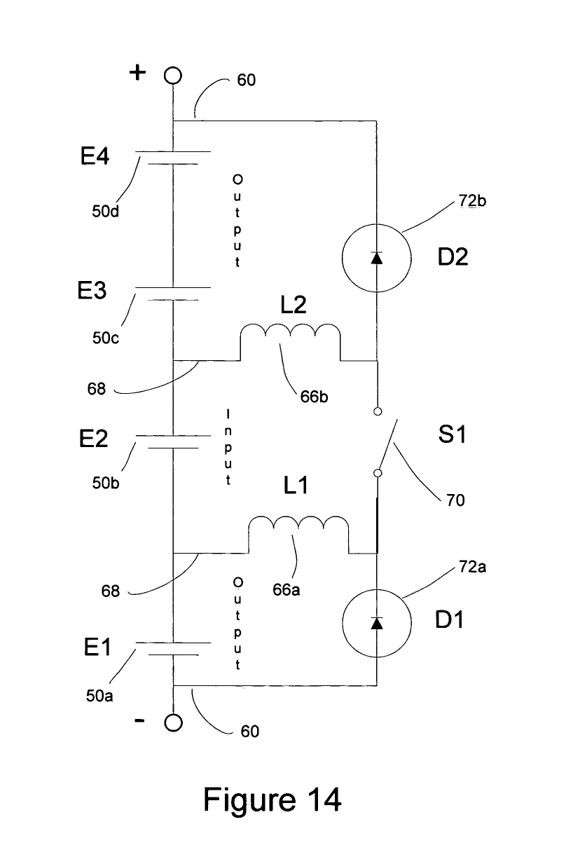

FIG. 14 shows another configuration of an energy transfer element whereby two terminals 68 are used as both input terminals and output terminals. A single switch 70 and two rectifiers 72a and 72b comprise the steering circuit. Two inductors 66a and 66b serve as the energy storage elements. This circuit has the advantage of being able to quickly redistribute charge from the energy device 50b across the input terminals to all of the other devices 50a, 50c, and 50d in the string with a low cost configuration that only requires one switch 70 and relatively inexpensive inductors 66a and 66b. As illustrated in FIG. 14, when the switch 70 is closed, current ramps up in the inductors 66a and 66b, conducting through the inductors 66a and 66b, switch 70, and energy device 50b, thereby removing energy from 50b. Opening switch 70 causes the current in the inductors 66a and 66b to decrease. The current in inductor 66a conducts through 66a, the rectifier 72a, and energy device 50a, thereby transferring energy to device 50a. The current in inductor 50b conducts through 50b, the rectifier 72b, energy device 50c and energy device 50d, thereby transferring charge to energy devices 50c and 50d.

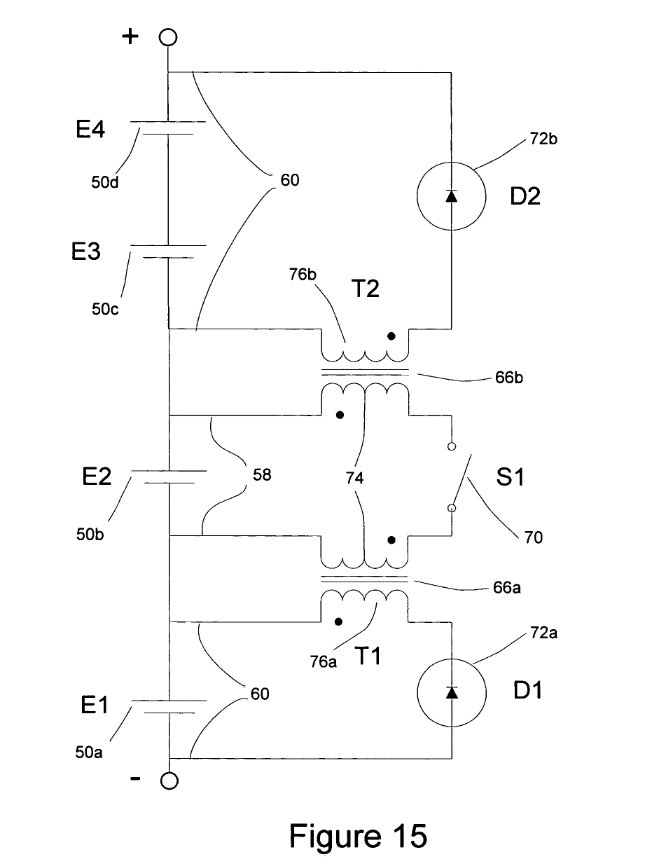

FIG. 15 illustrates an energy transfer element similar to that shown in FIG. 14 where transformers 66a and 66b are used instead of inductors. This circuit also has the advantage of being able to quickly redistribute charge from a single energy device to all of the other energy devices in the string. As the use of transformers provides output terminals 60 that are independent of the input terminals 58, this configuration allows energy to be transferred to additional combinations of energy devices in the string. As illustrated in FIG. 15, when the switch 70 is closed, current ramps up in the primary winding 74 of each transformer 66a and 66b, conducting through the primary windings 74, switch 70, and energy device 50b, thereby removing energy from energy device 50b. Opening switch 70 causes the current in each primary winding 74 to transfer to the corresponding secondary windings 76a and 76b and to decrease. The current in transformer 66a conducts through the secondary winding 76a, the rectifier 72a, and energy device 50a, thereby transferring charge to energy device 50a. The current in transformer 66b conducts through the secondary winding 76b, rectifier 72b, energy device 50cand energy device 50d, thereby transferring charge to energy devices 50c and 50d.

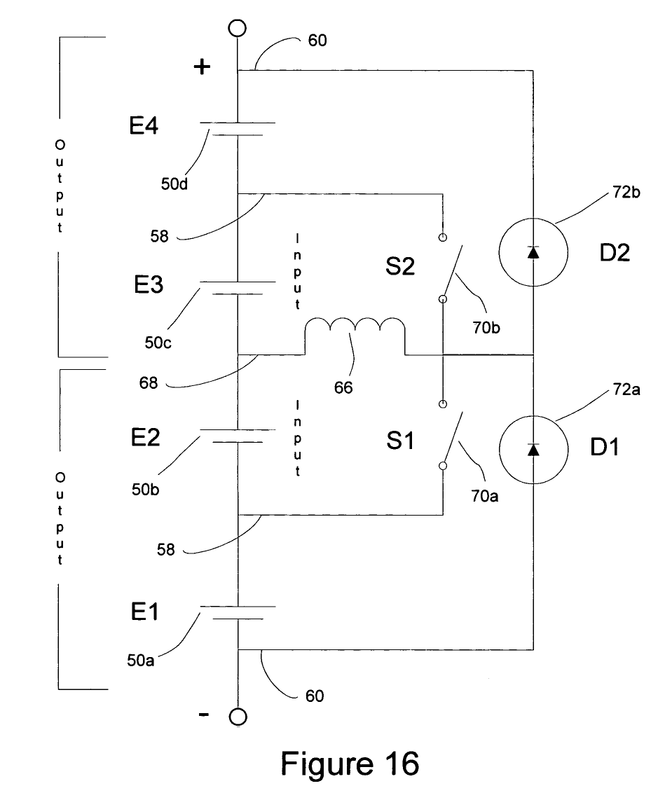

FIG. 16 shows a configuration of an energy transfer element with two sets of input terminals and two sets of output terminals. It has the benefit of being able to transfer energy from either one of two sets of adjacent energy devices 50a and 50b to the other energy devices in the string while requiring just one energy storage element 66. The energy transfer element has three input terminals 58 and 68. The steering circuit consists of two switches 70a and 70b and two diodes 72a and 70b. The energy storage element 66 is a single inductor. There are three output terminals 60 and 68. As illustrated in FIG. 16, opening and closing switch 70a transfers charge from energy device 50b to devices 50c and 50d. Opening and closing switch 70b transfers energy from energy device 50c to energy devices 50a and 50b. As illustrated in FIG. 16, when switch 70a is closed, current ramps up in inductor 66, conducting through inductor 66, switch 70a, and energy device 50b, thereby removing charge from energy device 50b. Opening switch 70a causes the current in inductor 66 to decrease. The current in inductor 66 conducts through inductor 66, rectifier 72b, energy device 50c, and energy device 50d, thereby transferring charge to energy devices 50c and 50d. When switch 70b is closed, current ramps up in inductor 66, conducting through inductor 66, switch 70b, and energy device 50c, thereby removing charge from energy device 50c. Opening switch 70b causes the current in inductor 66 to decrease. The current in inductor 66 conducts through inductor 66, rectifier 72a, energy device 50a, and energy device 50b, thereby transferring charge to energy devices 50a and 50b.

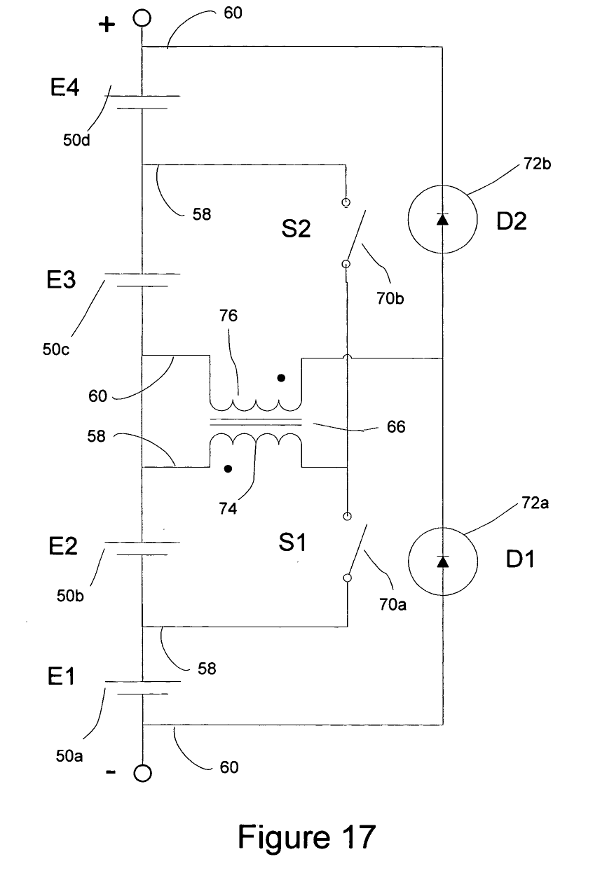

FIG. 17 shows an energy transfer element equivalent to that illustrated in FIG. 16 where the inductor has been replaced with a transformer 66. As with the circuit of FIG. 16, the circuit of FIG. 17 has the benefit of being able to transfer energy from either one of two sets of adjacent energy devices 50b and 50c to other energy devices in the string while requiring just one transformer 66. As illustrated in FIG. 17, when switch 70a is closed, current ramps up in the primary winding 74 of transformer 66, conducting through the primary winding 74, switch 70a, and energy device 50b, thereby removing energy from energy device 50b. Opening switch 70a causes the current to transfer to secondary winding 76 of the transformer 66 and to decrease. The current in secondary winding 76 conducts through secondary winding 76, rectifier 72b, energy device 50c, and energy device 50d, thereby transferring charge to energy devices 50c and 50d. When switch 70b is closed, current ramps up in primary winding 74 of the transformer 66, conducting through primary winding 74, switch 70b, and energy device 50c, thereby removing charge from energy device 50c. Opening switch 70b causes the current to transfer to the secondary winding 76 of the transformer 66 and to decrease. The current in the secondary winding 76 conducts through secondary winding 76, rectifier 72a, energy device 50a, and energy device 50b, thereby transferring charge to energy devices 50a and 50b.

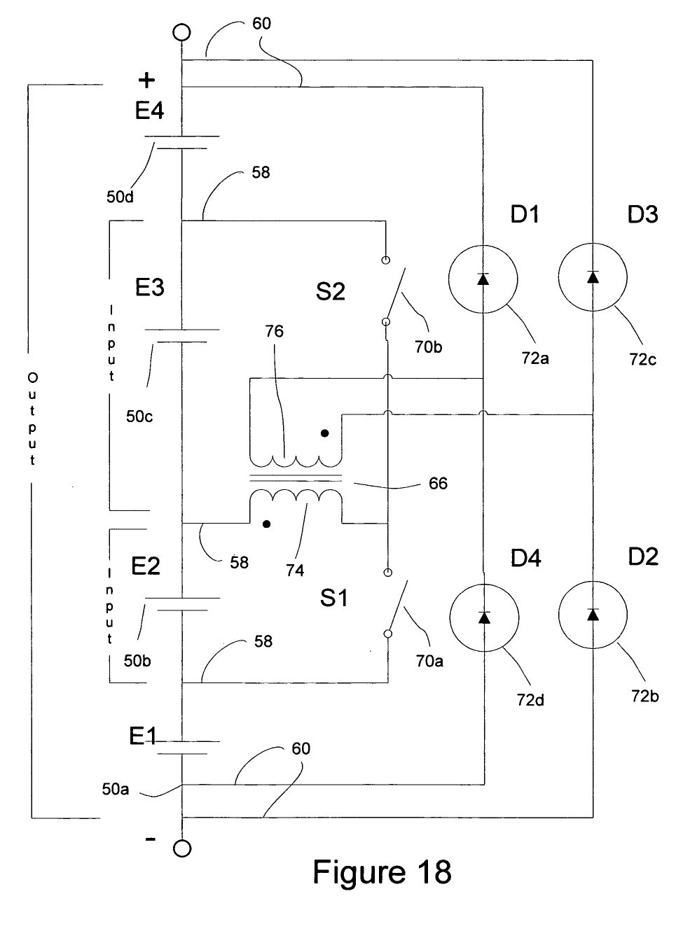

FIG. 18 shows a configuration similar to that illustrated in FIG. 17. Two additional rectifiers and output terminals 60 have been added to the steering circuit. This energy transfer element has an advantage of being able to transfer charge from either one of two adjacent energy elements 50b and 50c and redistribute the charge to the entire string of energy devices 50a, 50b, 50c, and 50d using only one transformer 66. As configured in FIG. 18, opening and closing switch 70a transfers energy from energy device 50b to all of the energy devices 50a, 50b, 50c, and 50d in the string. Opening and closing switch 70b transfers energy from energy device 50c to all of the energy devices 50a, 50b, 50c, and 50d in the string. When switch 70a is closed, current ramps up in the primary winding 74 of the transformer 66, conducting through the primary winding 74, switch 70a, and energy device 50b, removing charge from energy device 50b. Opening switch 70a causes the current to transfer to the secondary winding 76 of the transformer 66 and to decrease. The current in the secondary winding 76 conducts through the secondary winding 76, rectifiers 72c and 72d, and energy devices 50a, 50b, 50c, and 50d, charging the entire string. When switch 70b is closed, current ramps up in the primary winding 74 of the transformer 66, conducting through primary winding 74, switch 70b, and energy device 50c, removing energy from energy device 50c. Opening switch 70b causes the current to transfer to secondary winding 76 of transformer 66 and to decrease. The current in secondary winding 76 conducts through secondary winding 76, rectifiers 72a and 72b, and energy devices 50a, 50b, 50c, and 50d, charging the entire string.

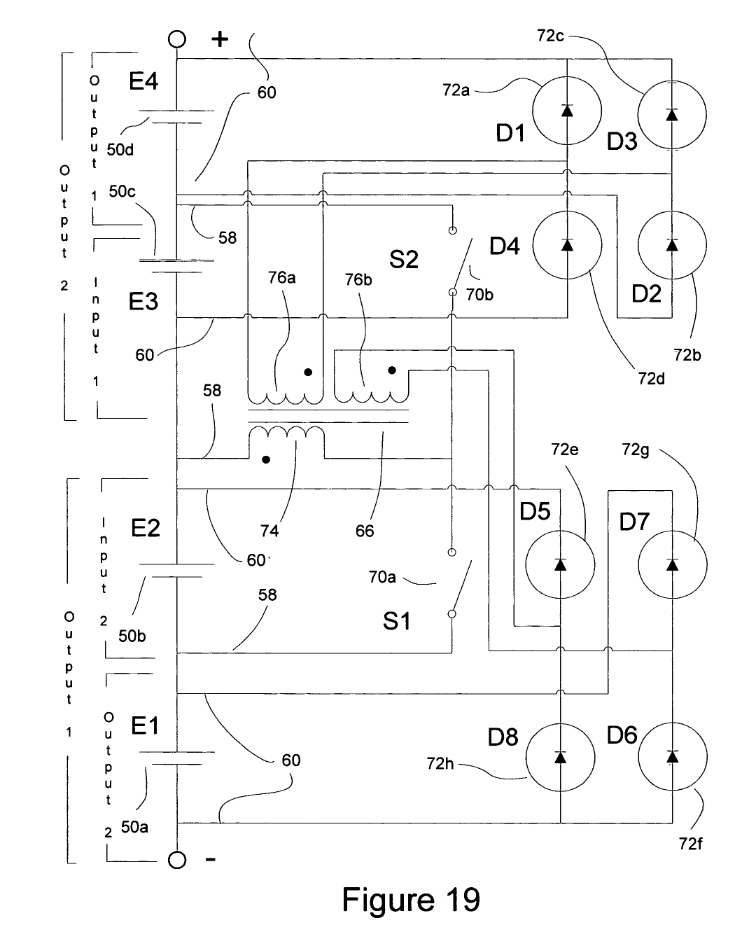

FIG. 19 shows an extension of the circuit illustrated in FIG. 18, generated by adding an additional secondary winding to the transformer. The energy transfer element of FIG. 19 redistributes charge to all of the string devices 50a, 50b, 50c, and 50d except the device from which charge is being taken. This results in faster and more efficient energy transfer among the string of energy devices. Modulating switch 70a removes energy from device 50b and transfers it to all of the other energy devices 50a, 50c, and 50d. Modulating switch 70b removes charge from energy device 50c and transfers it to all of the other energy devices 50a, 50b, and 50d. When switch 70a is closed, current ramps up in the primary winding 74 of the transformer 66, conducting through primary winding 74, switch 70a, and energy device 50b, removing energy from energy device 50b. Opening switch 70a causes the current to transfer to the secondary windings 76a and 76b of the transformer 66 and to decrease. The current in secondary winding 76a conducts through secondary winding 76a and rectifiers 72c and 72d, charging energy devices 50c and 50d. The current in secondary winding 76b conducts through secondary winding 76b and rectifiers 72g and 72h, charging energy device 50d. When switch 70b is closed, current ramps up in primary winding 74 of transformer 66, conducting through primary winding 74, switch 70b, and energy device 50c, removing energy from energy device 50c. Opening switch 70b causes the current to transfer to secondary windings 76a and 76b of the transformer 66 and to decrease. The current in secondary winding 76a conducts through secondary winding 76a and rectifiers 72a and 72b, charging energy device 50d. The current in the second secondary winding 76b conducts through secondary winding 76b and rectifiers 72e and 72f, charging energy devices 50a and 50b.

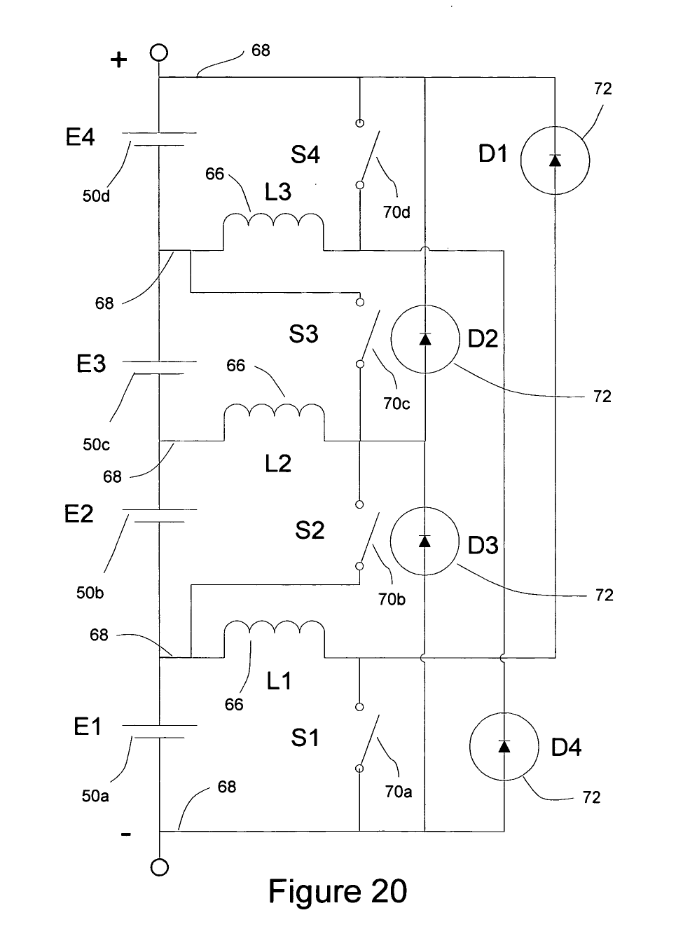

FIG. 20 shows another configuration of an energy transfer circuit for a series connected string of four energy devices 50a, 50b, 50c, and 50d using three energy transfer elements. It contains one energy transfer element illustrated in FIG. 5. It contains one energy transfer element illustrated in FIG. 6. It contains one energy transfer element illustrated in FIG. 16. It is nearly identical to the energy transfer circuit shown in FIG. 7. It differs only in that it contains one less energy storage device 66. Modulating switch 70a transfers energy from energy device 50a to the energy devices 50b, 50c, and 50d. Modulating switch 70b transfers energy from energy device 50b to the energy devices 50c and 50d. Modulating switch 70c transfers energy from energy device 50c to devices 50a and 50b. Modulating switch 70d transfers energy from energy device 50d to devices 50a, 50b, and 50c.

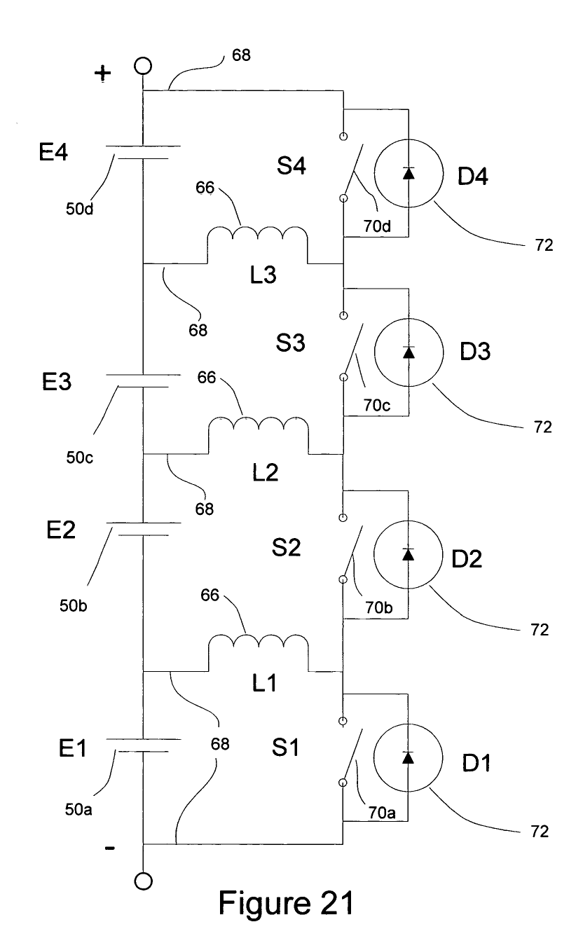

FIG. 21 shows yet another configuration of an energy transfer circuit for a string of four energy devices 50a, 50b, 50c, and 50d. It is similar to the circuit illustrated in FIG. 20 and differs in that the steering circuit rectifiers 72 have been rearranged such that one rectifier 72 is connected in parallel with each of the steering circuit switches 70a, 70b, 70c, and 70d. This configuration is well suited for implementation with field effect transistors (MOSFET's) as each parallel switch and rectifier combination may be realized with a single MOSFET. For example, an energy transfer circuit for a series connected string of four energy devices can be realized with only four MOSFET's and three inductors. Modulating any one of the switches 70a, 70b, 70c, and 70d in the circuit transfers energy from one corresponding energy device to all of the other energy devices in the string. Thus, this energy transfer circuit configuration provides for a very fast, efficient and cost effective balancing module. Modulating switch 70a transfers energy from the energy device 50a to the other energy devices 50b, 50c, and 50d. Likewise, modulating switch 70b transfers energy from the energy device 50b to the other energy devices 50a, 50c, and 50d. Modulating switch 70c transfers energy from the energy device 50c to the other energy devices 50a, 50b, and 50d. Modulating switch 70d transfers energy from the energy device 50d to the other energy devices 50a, 50b, and 50c.

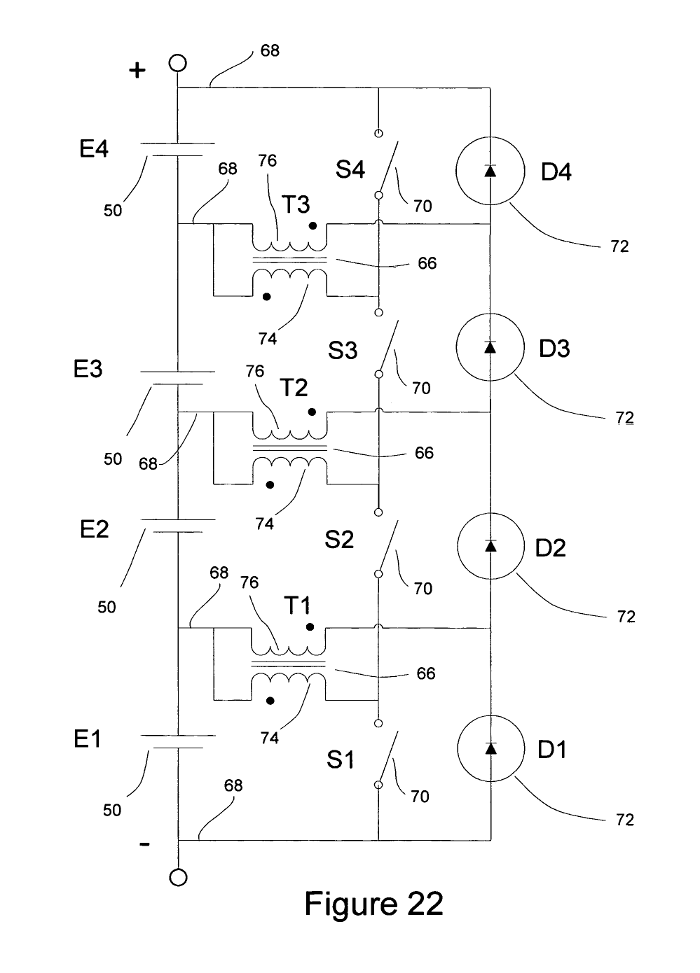

FIG. 22 shows an equivalent of the energy transfer circuit in FIG. 21 where the inductors have been replaced by transformers 66. As the circuit illustrated in FIG. 21, modulating any one switch 70 transfers energy from one corresponding energy device 50 to all of the other energy devices 50 in the string.

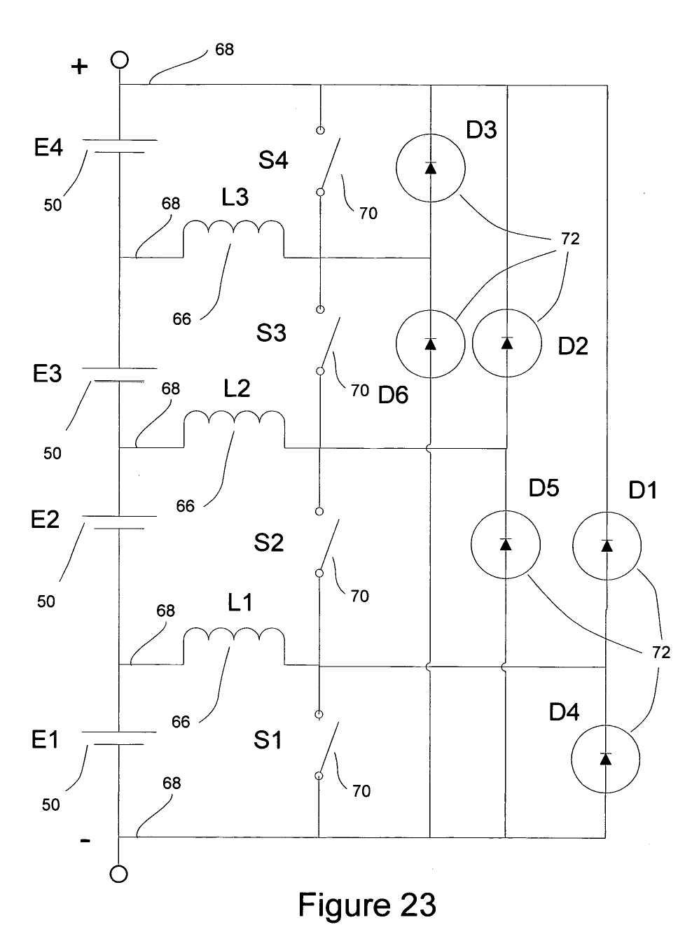

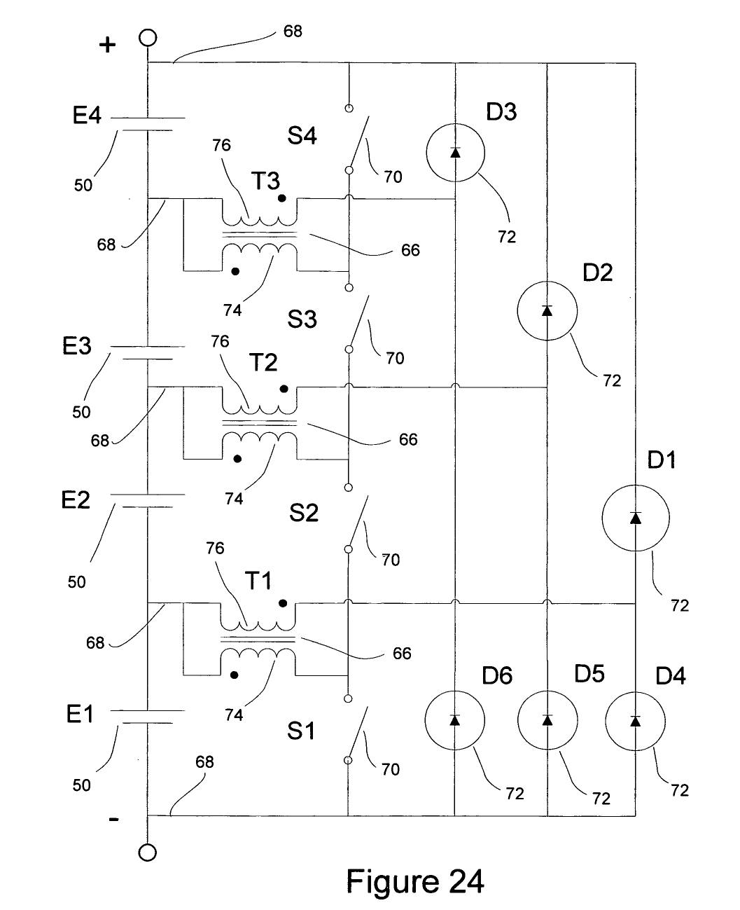

FIG. 23 shows another configuration of an energy transfer circuit for a series string of four energy devices 50. It is similar to the energy transfer circuit illustrated in FIG. 21 with additional rectifiers 72 added to the steering circuit. Like the circuit illustrated in FIG. 21, modulating any one switch 70 transfers energy from the energy device 50 across from that switch to all of the other energy devices 50 in the string. However, the circuit illustrated in FIG. 23 has an additional feature in that charge is distributed more equally among all of the other energy devices. FIG. 24 shows an equivalent of the energy transfer circuit in FIG. 23 where the inductors have been replaced by transformers 66.

### CONCLUSIONS, RAMIFICATIONS, AND SCOPE

The disclosed method of constructing an energy transfer element comprised of a steering circuit and one or more energy storage elements provides a means to configure a wide variety of energy transfer circuits. The ranges of specific energy transfer circuits that may be defined by this method are more numerous than what can be described herein within reasonable space. The specific configurations described herein have been selected to provide adequate illustration of the invention and instruction for one skilled in the art to adequately understand the methodology to construct a variety of additional configurations of energy transfer elements and energy transfer circuits for a variety of specific applications.

It should also be noted that a wide variety and combination of control methods and algorithms commonly known to those skilled in the art may be applied to design a variety of energy transfer circuit controllers. These methods include the use of various pulse width modulation (PWM) techniques to modulate the steering circuit switches, and the use of various types of linear and nonlinear feedback regulators. These regulator configurations may include proportional, integral, derivative (PID) regulators, hysteresis band regulators, sliding mode regulators, and others to regulate either the potential of energy devices, the rate of charge transfer (transfer current) between energy devices, or both. These known control methods may also be used to regulate sensed temperature of the energy transfer circuit or to limit the rate of charge transfer based on sensed temperature in order to provide over-temperature limiting and protection for the energy transfer module.

It is thus seen that a method and means is now provided for transferring energy between a series string of a plurality of energy devices that substantially improves upon and overcomes problems and shortcomings of prior string management means and methods. It should be noted the configurations of the energy transfer circuits and energy transfer elements described are only a few of the many configurations that are possible and that the invention is not limited to the embodiments set forth herein as illustrative. Many additional embodiments of the invention are possible with a variety of additional circuit configurations and control methodologies.

1. An energy transfer module comprising at least one energy transfer element wherein each energy transfer element comprises:
a) a steering circuit;
b) at least one energy storage element;
whereby said steering circuit may be comprised of switches and rectifiers, whereby said steering circuit may be connected to a plurality of series connected energy devices selected from the group consisting of energy storage devices and energy sources, and whereby a controller may be connected to said energy transfer elements with means to control said energy transfer elements to transfer energy from at least one energy device to at least one energy device.

2. The energy transfer module of claim 1 further comprising a controller wherein the controller provides means to control the energy transfer elements, whereby energy may be transferred from at least one energy device to at least one energy device.

3. The energy transfer module of claim 2 further providing means to measure the charge state of at least one energy device, whereby the controller may control said energy transfer elements to transfer energy between energy devices based on measured charge states.

4. The energy transfer module of claim 2 further providing means to measure temperature, whereby said controller may control the rate of energy transfer between said energy devices as a function of measured temperature, whereby module temperature may be limited by reducing the rate of energy transfer and internally generated heat as the measured temperature increases.

5. The energy transfer module of claim 3 further providing means to measure temperature, whereby said controller may control the rate of energy transfer between said energy devices as a function of measured temperature, whereby module temperature may be limited by reducing the rate of energy transfer and internally generated heat as the measured temperature increases.

6. An energy transfer module comprising:
a. an energy storage element connected to at least one first input terminal and at least one first output terminal of the module;
b. at least one controlled switching device wherein each controlled switching device is connected in series with the energy storage element between a pair of input terminals comprising said first input terminal and a second input terminal of the module;
c. at least one rectifier wherein each rectifier is connected in series with the energy storage element between a pair of output terminals comprising said first output terminal and a second output terminal of the module;
whereby the module may be connected to a plurality of series connected energy devices selected from the group consisting of energy storage devices and energy sources, whereby each said input terminal pair may be connected across at least one adjacent energy device, whereby each said output terminal pair may be connected across at least one adjacent energy device, and whereby a controller may be connected to said controlled switching devices with means to turn said switching devices on and off to transfer energy from the energy devices connected across the input terminals to the energy devices connected across the output terminals.

7. The energy transfer module of claim 6 wherein the said energy storage element is an inductor, whereby one terminal of said inductor may be connected to said first input terminal and said first output terminal, whereby the second terminal of the inductor may be connected to said controlled switching device and said rectifier, whereby said pair of input terminals may be connected across at least one energy device, and whereby said pair of output terminals may be connected across at least one energy device.

8. The energy transfer module of claim 6 wherein said energy storage element is a transformer having a plurality of primary windings and a plurality of secondary windings, whereby each said primary winding may be connected in series with one said controlled switching device between one said pair of input terminals, whereby each said secondary winding may be connected in series with one said rectifier between one said pair of output terminals, whereby each said pair of input terminals may be connected across at least one energy device, and whereby each said pair of output terminals may be connected across at least one energy device.

9. The energy transfer module of claim 8 further providing at least one additional rectifier wherein each additional rectifier is connected in series with at least one said primary winding and one terminal selected from the group consisting of said input terminals and output terminals, whereby said additional rectifiers may be connected to said terminals such that stored energy may be recovered into said energy devices when said switch is opened, and whereby transformer magnetizing currents may be more rapidly extinguished when said switch is opened.

10. An energy transfer module comprising:
a. a first energy storage element connected to a first input terminal of the module;
b. a second energy storage element connected to a second input terminal of the module;
c. a controlled switching device connected in series with the energy storage elements;
d. a first rectifier connected to a first output terminal of the module and in series with the first energy storage element;
e. a second rectifier connected to a second output terminal of the module and in series with the second energy storage element;
whereby the module may be connected to a plurality of series connected energy devices selected from the group consisting of energy storage devices and energy sources, whereby the input terminals may be connected across at least one adjacent energy device, whereby the output terminals may be connected across at least one adjacent energy device, and whereby a controller may be connected to the controlled switching device with means to turn said switching device on and off to transfer energy from the energy devices connected across the input terminals to the energy devices connected across the output terminals.

11. The energy transfer module of claim 10 wherein said energy storage elements are inductors, whereby said first input terminal is at a lower potential than said second input terminal, whereby said first output terminal is at a potential at least as low as the potential of the first input terminal, whereby said second output terminal is at a potential at least as high as the second input terminal, whereby said pair of input terminals may be connected across at least one energy device, and whereby said pair of output terminals may be connected across at least one energy device.

12. The energy transfer module of claim 10 wherein said energy storage elements are transformers, whereby a primary winding of said transformers may be connected to said input terminals and in series with said controlled switching device, whereby a secondary winding of said first transformer may be connected in series with said first rectifier between said first output terminal and a third output terminal, whereby a secondary winding of said second transformer may be connected in series with said second rectifier between said second output terminal and a fourth output terminal, whereby said first and third output terminals may be connected across at least one adjacent energy device, and whereby said second and fourth output terminals may be connected across at least one adjacent energy device.

13. The energy transfer module of claim 12 further providing at least one additional rectifier wherein each additional rectifier is connected in series with at least one said primary winding and one terminal selected from the group consisting of said input terminals and output terminals, whereby said additional rectifiers may be connected to said terminals such that stored energy may be recovered into said energy devices when said switch is opened, and whereby transformer magnetizing currents may be more rapidly extinguished when said switch is opened.

14. An energy transfer module comprising:
a. at least one energy storage element wherein a first energy storage element is connected to a first intermediate terminal of the module and any additional energy storage elements are connected to additional intermediate terminals;
b. at least two controlled switching devices wherein a first controlled switching device is connected to a low input terminal and in series with said first energy storage element, wherein a last controlled switching device is connected to a high input terminal and in series with said last energy storage element, and wherein any additional controlled switching device is connected in series with two said energy storage elements;
c. at least one first rectifier wherein a first rectifier is connected to a low output terminal and in series with said first energy storage element, and wherein a first rectifier is connected in series with each additional energy storage element and connected to a low output terminal;
d. at least one second rectifier, wherein a second rectifier is connected to a high output terminal and in series with said first energy storage element, and wherein a second rectifier is connected in series with each additional energy storage element and connected to a high output terminal;
whereby the module may be connected to a plurality of series connected energy devices selected from the group consisting of energy storage devices and energy sources, whereby said low output terminals may be connected to terminals of energy devices, whereby said low input terminal may be connected to a terminal of an energy device which is at a potential at least as high as the low output terminals, whereby said first intermediate terminal may be connected to a terminal of an energy device which is at a potential at least as high as the low input terminal, whereby any subsequent intermediate terminals may be connected to a terminal on an energy device that is at a potential at least as high as the terminal of the previous intermediate terminal, whereby said high input terminal may be connected to a terminal of an energy device which is at a potential at least as high as the highest potential intermediate terminal, whereby said high output terminals may be connected to terminals of energy devices which are at potentials at least as high as said high input terminal, and whereby a controller may be connected to said controlled switching devices with means to turn said switching devices on and off to transfer energy from at least one energy device to at least one energy device.

15. The energy transfer module of claim 14 wherein said energy storage elements are inductors, one end of which is connected to the corresponding said intermediate terminal and the other end is connected to the corresponding said controlled switching devices and said rectifiers.

16. The energy transfer module of claim 14 wherein said energy storage elements are transformers, whereby a primary winding of each said transformer may be connected to the corresponding said intermediate terminal and said controlled switching devices, and whereby a secondary winding of each said transformer may be connected to the corresponding said intermediate terminal and said rectifiers.

17. The energy transfer module of claim 16 further providing at least one additional rectifier wherein each additional rectifier is connected in series with at least one said primary winding and one terminal selected from the group consisting of said input terminals and output terminals, whereby said additional rectifiers may be connected to said terminals such that stored energy may be recovered into said energy devices when at least one of said switches are opened, and whereby transformer magnetizing currents may be more rapidly extinguished when at least one of said switches are opened.

18. An energy transfer module comprising:
a. a transformer with a primary winding and at least one secondary winding, wherein said primary winding is connected to an intermediate input terminal of the module;
b. a first controlled switching device connected to a low input terminal of the module and in series with the primary winding of the transformer;
c. a second controlled switching device connected to a high input terminal of the module and in series with the primary winding of the transformer;
d. at least one first rectifier connected to at least one first output terminal of the module, wherein one of said first rectifiers is in series with each said secondary winding and connected to one of said first output terminals;
e. at least one second rectifier connected to at least one second output terminal of the module, wherein one of said second rectifiers is in series with each of said secondary windings and connected to one of said second output terminals;
f. at least one third rectifier connected to at least one third output terminal of the module, wherein one of said third rectifiers is in series with each of said secondary windings and connected to one of said third output terminals;
g. at least one forth rectifier connected to at least one forth output terminal of the module, wherein one of said forth rectifiers is in series with each of said secondary windings and connected to one of said forth output terminals;
whereby the module may be connected to a plurality of series connected energy devices selected from the group consisting of energy storage devices and energy sources, whereby said high input terminal may be connected to the high side of a first energy device, whereby said intermediate input terminal may be connected to the high side of a second energy device which is at a lower potential than the first energy device, whereby said low input terminal may be connected to the low side of the second energy device or a third energy device which is at a lower potential than the second energy device, whereby each pair of said first and second output terminals may be connected across at least one adjacent energy device, whereby each pair of said third and forth output terminals may be connected across at least one adjacent energy device, and whereby a controller may be connected to the controlled switching devices with means to turn said switching device on and off to transfer energy from the energy devices connected across the input terminals to the energy devices connected across the output terminals.

19. The energy transfer module of claim 18 further providing at least one additional rectifier wherein each additional rectifier is connected in series with at least one said primary winding and one terminal selected from the group consisting of said input terminals and output terminals, whereby said additional rectifiers may be connected to said terminals such that stored energy may be recovered into said energy devices when at least one of said switches are opened, and whereby transformer magnetizing currents may be more rapidly extinguished when at least one of said switches are opened.

20. An energy transfer module comprising:
a) at least one energy storage element, wherein a first energy storage element is connected to a first intermediate terminal of the module and any additional energy storage elements are connected to additional intermediate terminals;
b) at least two controlled switching devices, wherein a first controlled switching device is connected to a low input terminal and in series with said first energy storage element, wherein a last controlled switching device is connected to a high input terminal and in series with the last said energy storage element, and wherein any additional controlled switching device is connected in series with two said energy storage elements;
c) at least two rectifiers, wherein a first rectifier is connected to said low output terminal and in series with said first energy storage element, wherein a last rectifier is connected to said high output terminal and in series with the last said energy storage element, and wherein any additional rectifier is connected in series with two said energy storage elements;
whereby the module may be connected to a plurality of series connected energy devices selected from the group consisting of energy storage devices and energy sources, whereby said low output terminal may be connected to a terminal of an energy device, whereby said low input terminal may be connected to a terminal of an energy device which is at a potential at least as high as said low output terminal, whereby said first intermediate terminal may be connected to a terminal of an energy device which is at a potential at least as high as the low input terminal, whereby any subsequent intermediate terminals may be connected to a terminal on an energy device that is at a potential at least as high as the terminal of the previous intermediate terminal, whereby said high input terminal may be connected to a terminal of an energy device which is at a potential at least as high as the highest potential intermediate terminal, whereby said high output terminal may be connected to a terminal of an energy device which is at a potential at least as high as said high input terminal, and whereby a controller may be connected to the controlled switching devices with means to turn said switching devices on and off to transfer energy from at least one energy device to at least one energy device.

21. The energy transfer module of claim 20 wherein said energy storage elements are inductors, whereby one end of said inductor is connected to the corresponding said intermediate terminal and the other end is connected to the corresponding said controlled switching devices and rectifiers.

22. The energy transfer module of claim 20 wherein said energy storage elements are transformers, whereby a primary winding of each transformer may be connected to the corresponding said intermediate terminal and the corresponding said controlled switching device, and whereby a secondary winding of each transformer may be connected to the corresponding said intermediate terminal and the corresponding said rectifiers.

23. The energy transfer module of claim 22 further providing at least one additional rectifier wherein each additional rectifier is connected in series with at least one said primary winding and one terminal selected from the group consisting of said input terminals and output terminals, whereby said additional rectifiers may be connected to said terminals such that stored energy may be recovered into said energy devices when at least one of said switches are opened, and whereby transformer magnetizing currents may be more rapidly extinguished when at least one of said switches are opened.

24. An energy transfer system comprising:
a) a plurality of series connected energy devices selected from the group consisting of energy storage devices and energy sources;
b) at least one energy transfer element comprising;
i) a steering circuit;
ii) at least one energy storage element;
c) at least one controller connected to the energy transfer elements with control means to transfer energy among said energy devices;
whereby said energy transfer elements may be connected to said energy devices, whereby each energy transfer element may transfer energy from at least one of said energy devices to at least one of said energy devices, and whereby at least one controller may be connected to said energy transfer elements with means to control said energy transfer elements to transfer energy between said energy devices.

25. The energy transfer system of claim 24 wherein said energy devices are further selected from the group consisting of batteries, capacitors, photovoltaic cells, fuel cells and combinations of a plurality of batteries, capacitors, photovoltaic cells, fuel cells, and inductors.

26. The energy transfer system of claim 24 further including at least one charger, whereby each charger may provide means to add charge to at least one energy device.

27. The energy transfer system of claim 24 further including at least one load, whereby each load may provide means to remove charge from at least one energy device.

28. The energy transfer system of claim 26 further including at least one load, whereby each load may provide means to remove charge from at least one energy device.

29. A method of constructing an energy transfer element comprising:
a) a steering circuit;
b) at least one energy storage element;
whereby said steering circuit may be comprised of switches and rectifiers, whereby said steering circuit may be connected to a plurality of series connected energy devices selected from the group consisting of energy storage devices and energy sources, and whereby a controller may be connected to said energy transfer elements with means to control said energy transfer elements to transfer energy from at least one energy device to at least one energy device.

30. The method of claim 29 further comprised of a method of constructing an energy transfer module comprising at least one energy transfer element.

31. The method of claim 30 further comprising a controller wherein the controller provides means to control the energy transfer elements, whereby energy may be transferred from at least one energy device to at least one energy device.

32. The method of claim 31 further comprising means to measure the charge state of at least one energy device, whereby the controller may control said energy transfer elements to transfer energy between energy devices based on measured charge states.

33. The method of claim 31 further comprising means to measure temperature, whereby said controller may control the rate of energy transfer between said energy devices as a function of measured temperature, whereby module temperature may be limited by reducing the rate of energy transfer and internally generated heat as the measured temperature increases.

34. The method of claim 32 further comprising means to measure temperature, whereby said controller may control the rate of energy transfer between said energy devices as a function of measured temperature, whereby module temperature may be limited by reducing the rate of energy transfer and internally generated heat as the measured temperature increases.

35. An energy transfer system comprising:
a) a plurality of series connected energy devices selected from the group consisting of energy storage devices and energy sources;
b) at least one energy transfer element wherein each energy transfer element transfers energy from one or more of said energy devices to two or more of said energy devices;
c) at least one controller connected to the energy transfer elements with control means to transfer energy among said energy devices;
whereby at least one said energy transfer element may be connected to said energy devices and whereby at least one said controller may be connected to said energy transfer elements with means to control said energy transfer elements to transfer energy between said energy devices.

36. The energy transfer system of claim 35 wherein said energy devices are further selected from the group consisting of batteries, capacitors, photovoltaic cells, fuel cells and combinations of a plurality of batteries, capacitors, photovoltaic cells, fuel cells, and inductors.

37. The energy transfer system of claim 35 further including at least one charger, whereby each charger may provide means to add charge to at least one energy device.

38. The energy transfer system of claim 35 further including at least one load, whereby each load may provide means to remove charge from at least one energy device.

39. The energy transfer system of claim 37 further including at least one load, whereby each load may provide means to remove charge from at least one energy device.

40. An energy transfer system comprising:
a) a plurality of series connected energy devices selected from the group consisting of energy storage devices and energy sources;
b) at least one energy transfer element wherein each energy transfer element transfers energy from two or more of said energy devices to one or more of said energy devices;
c) at least one controller connected to the energy transfer elements with control means to transfer energy among said energy devices;
whereby at least one said energy transfer element may be connected to said energy devices and whereby at least one said controller may be connected to said energy transfer elements with means to control said energy transfer elements to transfer energy between said energy devices.

41. The energy transfer system of claim 40 wherein said energy devices are further selected from the group consisting of batteries, capacitors, photovoltaic cells, fuel cells and combinations of a plurality of batteries, capacitors, photovoltaic cells, fuel cells, and inductors.

42. The energy transfer system of claim 40 further including at least one charger, whereby each charger may provide means to add charge to at least one energy device.

43. The energy transfer system of claim 40 further including at least one load, whereby each load may provide means to remove charge from at least one energy device.

44. The energy transfer system of claim 42 further including at least one load, whereby each load may provide means to remove charge from at least one energy device.
